(19) United States
(12) Patent Application Publication
(10) Pub. No.: US 2009/0199951 A1
(43) Pub. Date: Aug. 13, 2009

(54) VIBRATION WELDING METHOD AND SYSTEM

(76) Inventor: Paul H. Cathcart, Maple Park, IL (US)

Correspondence Address: Stephen G. Rudisill, Esq.;Nixon Peabody LLP, 48th Floor, 161 North Clark Street, Chicago, IL, 60601, US

(21) Appl. No.: 12/367,372

(22) Filed: Feb. 6, 2009

Related U.S. Application Data
(60) Provisional application No. 61/065,206, filed on Feb. 8, 2008.

(51) Int. Cl. B32B 37/10

(52) U.S. Cl. 156/73.1; 156/580.2

(57) ABSTRACT

A first thermoplastic part is simultaneously welded to second and third thermoplastic parts by fastening the first part to a tool mounted for linear vibration, the tool being connected to spring members urging the tool toward a central position and responsive to displacement of the tool from the central position for urging the tool back to the central position; fastening the second and third parts in stationary positions with surfaces of the second and third parts to be welded to the first part positioned adjacent different surfaces of the first part; pressing the second and third parts against the first part while (a) clamping the first part between the tool and a resonant mount and (b) imparting vibratory movement to the tool and thus to the first part in a direction substantially parallel to the surfaces to be welded. In one implementation, the resonant mount is supported on roller bearings.

### CROSS-REFERENCE TO RELATED APPLICATIONS

This application claims priority to U.S. Provisional Application Ser. No. 61/065,206 filed Feb. 8, 2008.

### FIELD OF THE INVENTION

The present invention relates generally to vibration welding, in particular linear vibration welding.

### BACKGROUND OF THE INVENTION

Conventional linear vibration welding physically moves one of two parts horizontally under pressure, creating heat through surface friction that melts and welds the parts together. Compared to ultrasonic welding, vibration welding operates at much lower frequencies, higher amplitudes and much greater clamping force. Linear vibration welding typically uses electromagnetic heads that eliminate wear and lubrication associated with bearing surfaces. Typical welding stages include:

1. Linear motion of one part against another generates friction between the two surfaces, producing heat at the joint.

2. The parts begin to melt at the joint. High heat generation from the high shear rate causes further melting and a thicker melt layer. As the melted layer thickens, the viscosity increases and the shear rate decreases resulting in less heating. Pressure on melting parts promotes fluid flow to create the joint.

3. The weld process is discontinued when the joint has reached its optimum strength. This is indicated when the parts melt at a rate equal to the outward flow rate at the joint.

4. With pressure maintained on the joint, the material re-solidifies, forming a molecular bond.

Portions of a known vibration welder 100 are illustrated in FIG. 1. Within a chassis 101 are provided a lower stationary nest 103 located on top of a machine lift table 105 and an upper vibrating nest 107 located below a vibration source 110. The vibration source 110 includes lamination carriers 111 and 111′, an electromagnetic coil 113 and a linear spring 115 coupled to the lamination carrier. As the electromagnetic coil 113 is energized with alternating polarities, the lamination carriers 111 and 111′ are moved in opposite directions to cause the vibrating upper nest 107 to vibrate. An operator console 120 is provided whereby an operator controls operation of the vibration welder 100.

FIG. 2 illustrates a center console for an automobile, which is a typical assembly made by linear vibration welding using the sequence of operations carried out in a conventional linear vibration welding machines, which sequence is illustrated in FIGS. 3A-3C:

1. Bin A is loaded flat onto a lower (non-vibrating) tooling mandrel 301 of welder.

2. Left panel B is loaded into upper (vibrating) tooling nest 303 of welder.

3. Bin and left panel are engaged under clamp pressure during first weld cycle and welded (FIG. 3B).

4. Bin A/panel B assembly is loaded into lower tooling 301′ of second welder.

5. Right panel C is loaded into upper tooling 303′ of second welder.

6. Right panel and first assembly are engaged under clamp pressure during second weld cycle and welded to produce a complete assembly (FIG. 3C).

The two-cycle nature of the foregoing process is slow and inefficient.

### Overview

In one embodiment, a method of simultaneously forming vibration welds between three or more subassemblies includes holding the subassemblies in a desired relation to one another to define at least two different weld planes and vibrating at least one of the subassemblies to simultaneously form a vibration weld in each of the at least two different weld planes. In another embodiment, a first thermoplastic part is simultaneously welded to second and third thermoplastic parts by fastening the first part to a tool mounted for linear vibration, the tool being connected to spring members urging the tool toward a central position and responsive to displacement of the tool from the central position for urging the tool back to the central position; fastening the second and third parts in stationary positions with surfaces of the second and third parts to be welded to the first part positioned adjacent different surfaces of the first part; pressing the second and third parts against the first part while (a) clamping the first part between the tool and a resonant mount and (b) imparting vibratory movement to the tool and thus to the first part in a direction substantially parallel to the surfaces to be welded. In one implementation, the resonant mount is supported on roller bearings.

### BRIEF DESCRIPTION OF THE DRAWINGS

The invention will be better understood from the following description of preferred embodiments together with reference to the accompanying drawings, in which:

FIG. 1 is a diagram illustrating portions of a known vibration welding machine.

FIG. 2 is a perspective view of a portion of a center console for the interior of an automobile, to be assembled using a linear vibration welding machine;

FIG. 3A is a diagrammatic illustration in perspective view of a known two-step vibration welding process;

FIG. 3B is a diagrammatic illustration in end view during a first step of the known two-step vibration welding process;

FIG. 3C is a diagrammatic illustration in end view during a second step of the known two-step vibration welding process;

FIG. 4A is a diagrammatic illustration in perspective view of a vibration simulwelding process;

FIG. 4B is a diagrammatic illustration in end view of the vibration simulwelding process of FIG. 4A;

FIG. 5 is an enlarged front perspective view of a vibration simulwelding tool with a front nest thereof in its fully open position;

FIG. 6 is a bottom perspective view of an upper tool included in the tool of FIG. 5;

FIG. 7 is a perspective view of a metal core of the upper tool of FIG. 6;

FIG. 8 is a top perspective view of a lower tool portion of the tooling of FIG. 5;

FIG. 9 is a top plan view of the tooling of FIG. 8;

FIG. 10 is a top perspective view of a lower tool portion of the tooling of FIG. 9 with the front nest in its fully closed position;

FIG. 11A is an exploded perspective view of a resonant mount included in the tooling of FIG. 5;

FIG. 11B is a side elevation of the resonant mount of FIG. 4A;

FIG. 12 is a partial cut-way view of a door assembly showing a pneumatic clamp diaphragm used to apply pressure to a subassembly during vibration welding; and

FIG. 13 is a left front perspective of a linear vibration welding machine having the tooling of FIG. 5 installed.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

First, a generic method of simultaneously producing multiple vibration welds—“vibration simulwelding”—between three or more subassemblies along two or more weld planes will be described. A particular apparatus that may be used to perform vibration simulwelding will then be described.

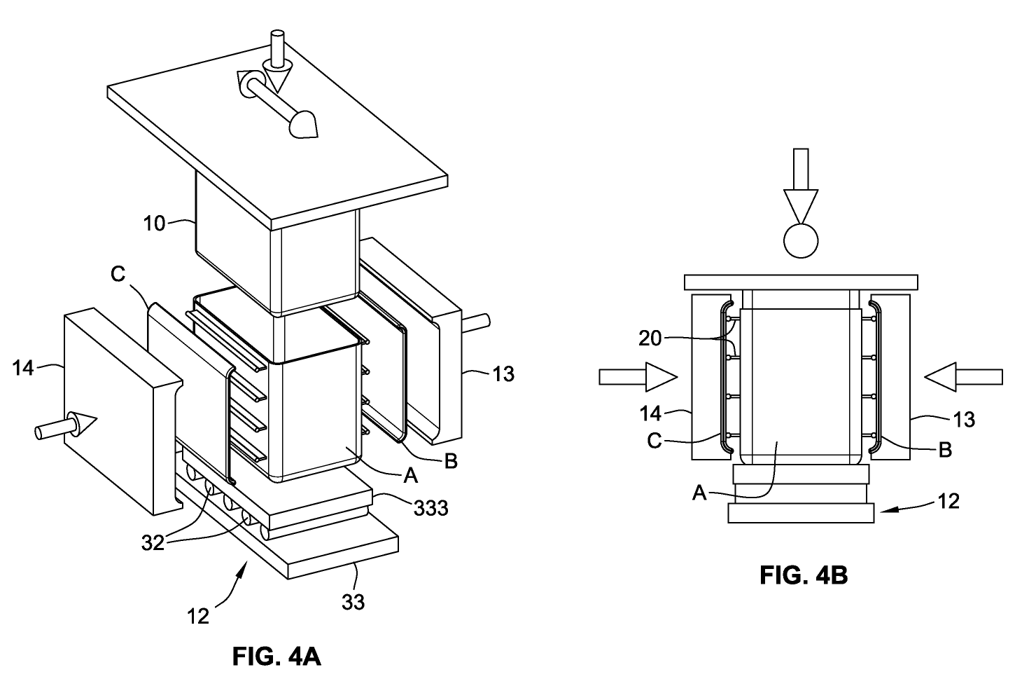

Referring to FIGS. 4A-4B, in the generic method, a first subassembly A is brought into contact with a resonant mount 12 and is engaged by upper tooling 10. The resonant mount 12 may include, for example, an upper plate 333, roller bearings 32 and a lower stationary plate 33. The first subassembly A is clamped by a clamping action of the upper tooling 10 and the resonant mount 12, the resonant mount 12 nevertheless allowing the first subassembly to be vibrated. Second and third subassemblies B and C are placed into side clamp nests 13 and 14 and pressed against the first subassembly A. The arrangement of FIG. 4B results, with the subassemblies in position and ready for vibration welding to begin. As seen therein, front and back vertical surfaces of the vibrating part A include multiple ribs 20 (“weld beads”) that engage opposed vertical surfaces of the stationary parts B and C. Vibration welding then occurs, with vibration being applied to the subassembly A in a direction perpendicular to the page. Note that the order of the foregoing steps may be varied, as is generally assumed throughout the present description.

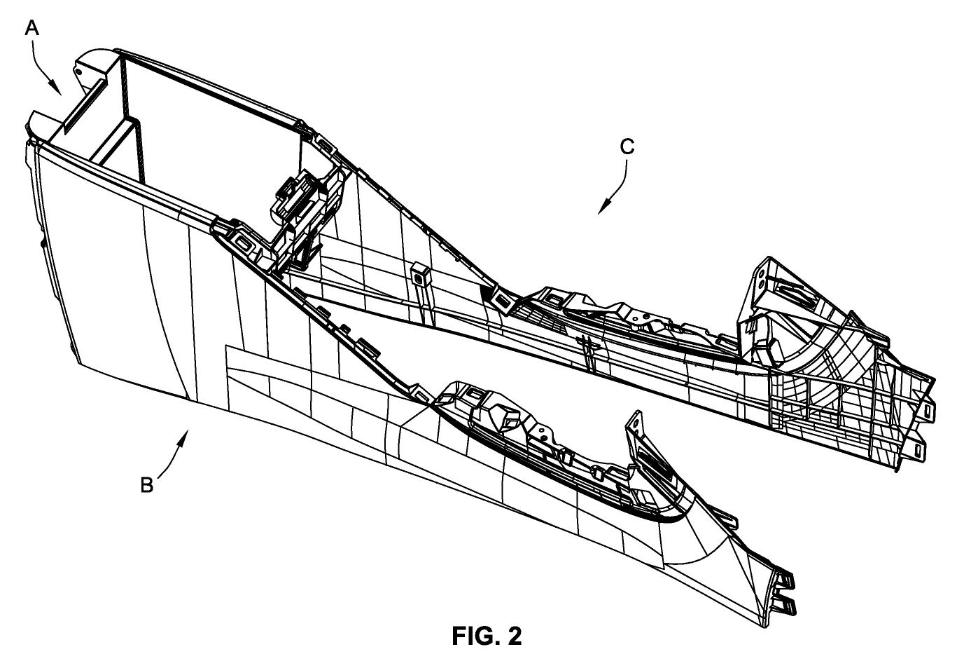

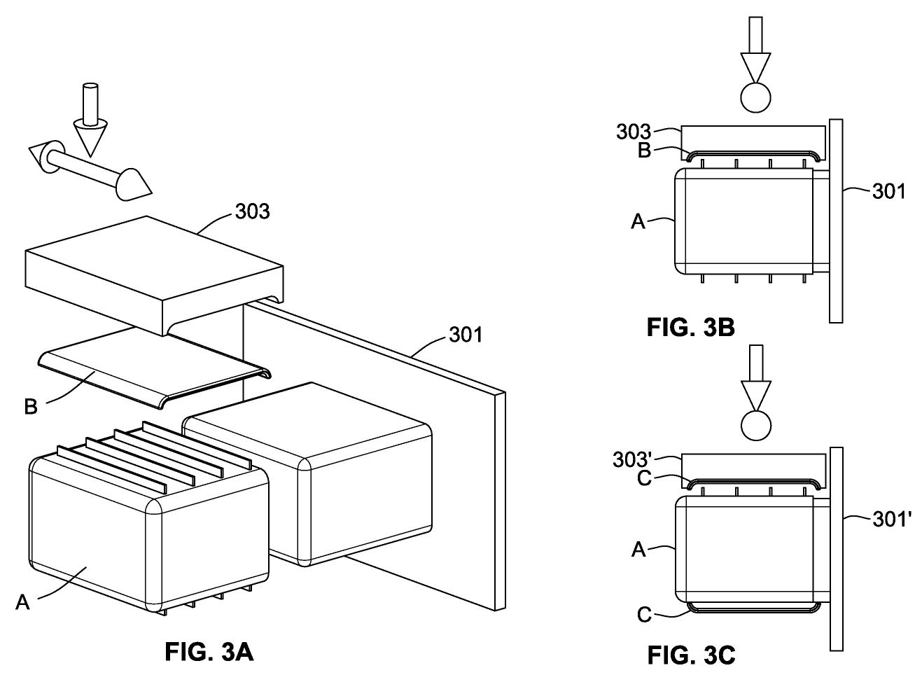

The foregoing method may be applied to the center console of FIG. 2. To make the center console illustrated in FIG. 2 using vibration simulwelding, each weld cycle may include the following stages, referring again to FIGS. 4A-4B:

1. Left panel B is loaded vertically into back nest of lower tooling (non-vibrating). Right panel C is loaded vertically into front nest of lower tooling. Bin A is loaded onto the resonant mount 12 in the lower tooling between the two side panels.

2. Bin A is engaged by the upper tool 10 under clamp pressure against the resonant mount 12 during the weld cycle.

3. Upper tooling, bin A, and resonant mount 12 go into resonance together. Bin A is maintained in clamped position by mount 12.

4. Side pressure is applied on panels B and C to force them against the vibrating bin A and produce the melt between the components, in both interfaces, in one cycle.

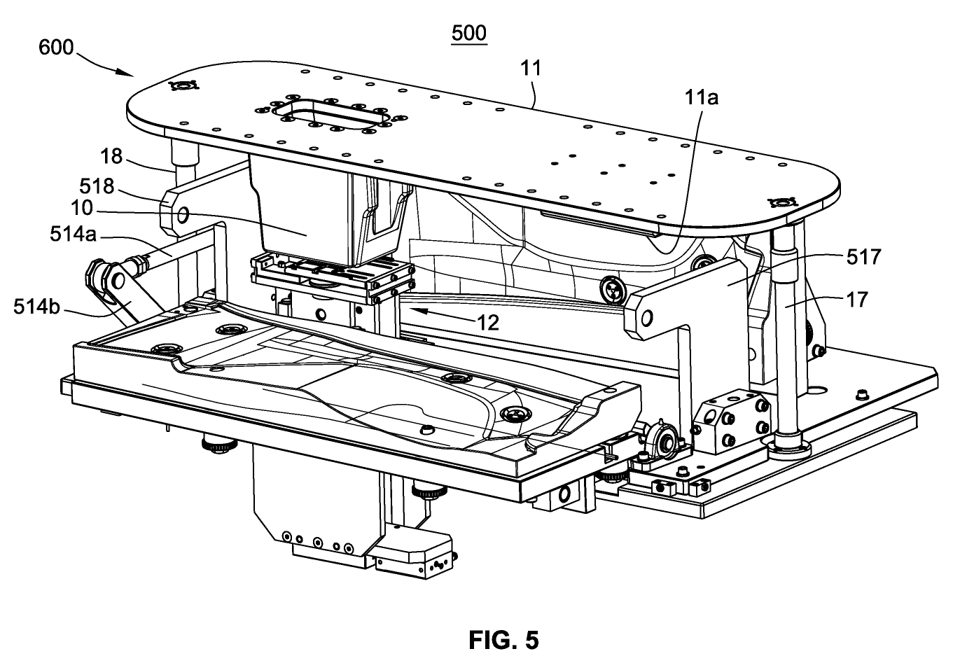

The present welding method can be executed in a conventional linear vibration welding machine equipped with special tooling illustrated in FIGS. 5-13.

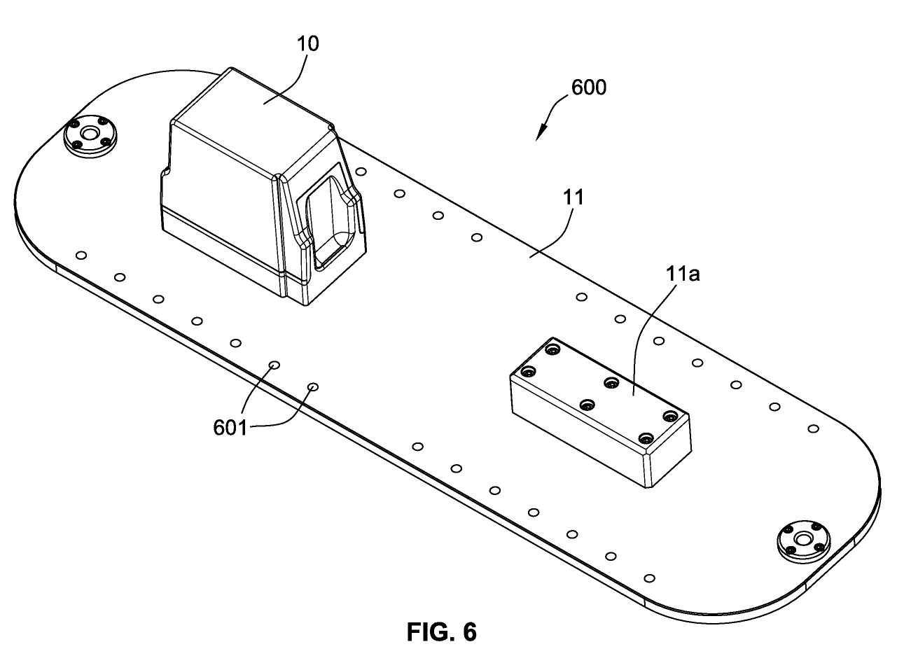

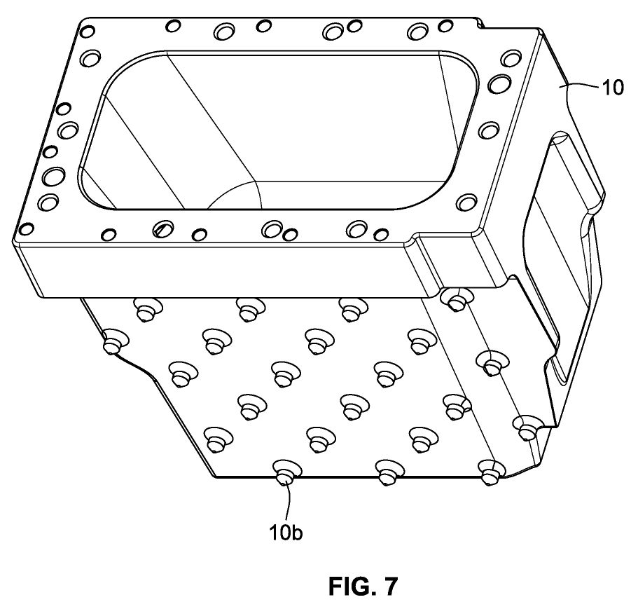

FIG. 5 shows a front perspective view of a vibration welding tool 500 in a clamping position but with a front door assembly open for visibility. An upper tool portion 600 includes a metal core 10 mounted on the underside of a tooling plate 11, the tooling plate 11 being mounted in turn to resilient posts 17 and 18 that allow for vibratory motion in the lengthwise direction of the tooling plate 11. The metal core 10 is seen more clearly in FIG. 6, showing a bottom perspective view of the upper tool portion 600. The metal core 10 engages one of the polymeric subassemblies to be vibration welded (e.g., the bin of FIG. 2) against lower tooling, to be described. A weight 11a is also attached to the underside of the tooling plate 11 to counterbalance the metal core 10. A perspective view of a suitable metal core 10, which may be provided with resilient nubs or studs 10b, is shown in FIG. 7. The resilient nubs 10b engage and retain the polymeric subassembly to be vibration welded.

Referring again to FIG. 5, the vibration welding tool 500 includes a resonant mount 12, described more fully below, that has raised position as shown in FIG. 5 and a lowered position. In the lowered position, and with a door assembly open, the resonant mount is ready to have placed thereon one of the subassemblies to be vibration welded (e.g., the bin of FIG. 2). In the raised position, the resonant mount holds the subassembly to be vibration welded (e.g., the bin of FIG. 2) against the metal core 10 of the upper tool 600, still allowing for vibration of the subassembly.

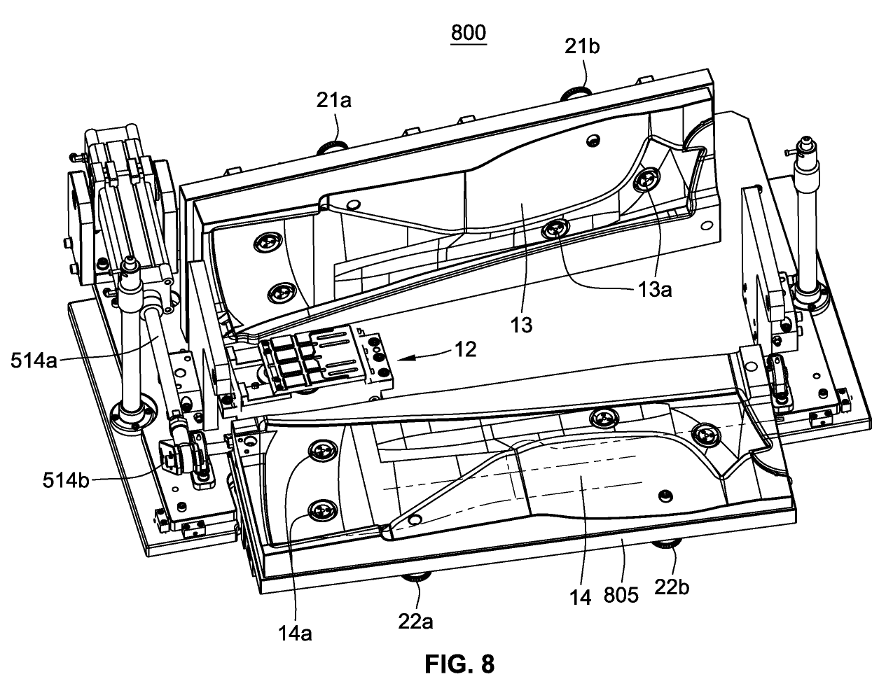

Referring to FIG. 8, a perspective view is shown of a lower tool portion 800 of the vibration welding tool 500, the upper tool portion 600 being omitted. The lower tool portion 800 includes the resonant mount 12 (shown in the lowered position), a stationary rear nest 13 for holding one of the subassemblies to be vibration welded (e.g., one of the side panels of FIG. 2), a front nest 14 provided in conjunction with a door assembly 805, the front nest 14 holding another one of the subassemblies to be vibration welded (e.g., another one of the side panels of FIG. 2), and a mechanism such as a pneumatic cylinder 514a and associated linkage 514b for closing the door assembly. In the illustrated embodiment, the subassemblies are held in the rear nest 13 and the front nest 14 by suction ports 13a and 14a, respectively. Also in the illustrated embodiment, adjustments 21a, 21b, etc. and 22a, 22b, etc., are provided allowing pre-adjusted hard stops to be set. During the welding operation, pressure applied to the nests 13 and 14 causes them to advance toward each other until the pre-adjusted hard stops are reached.

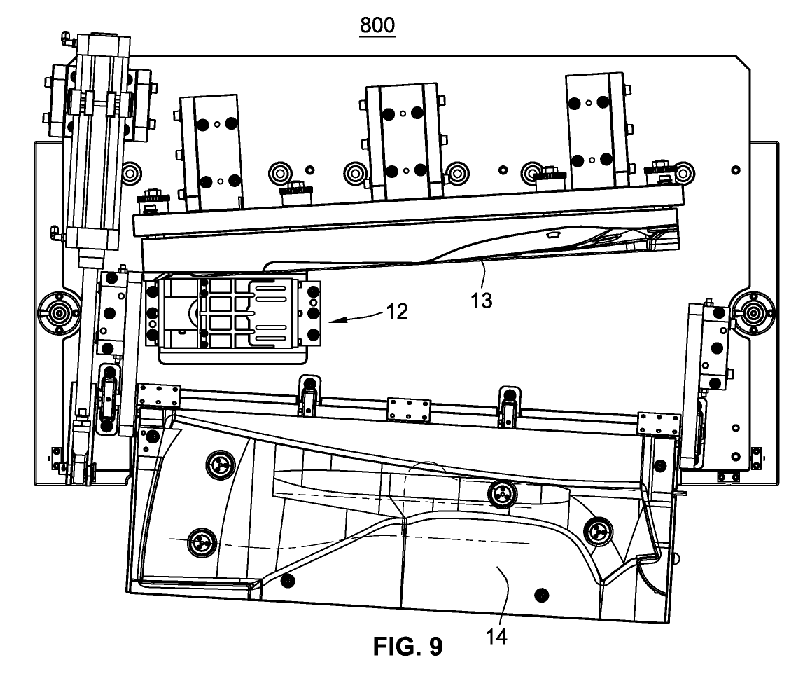

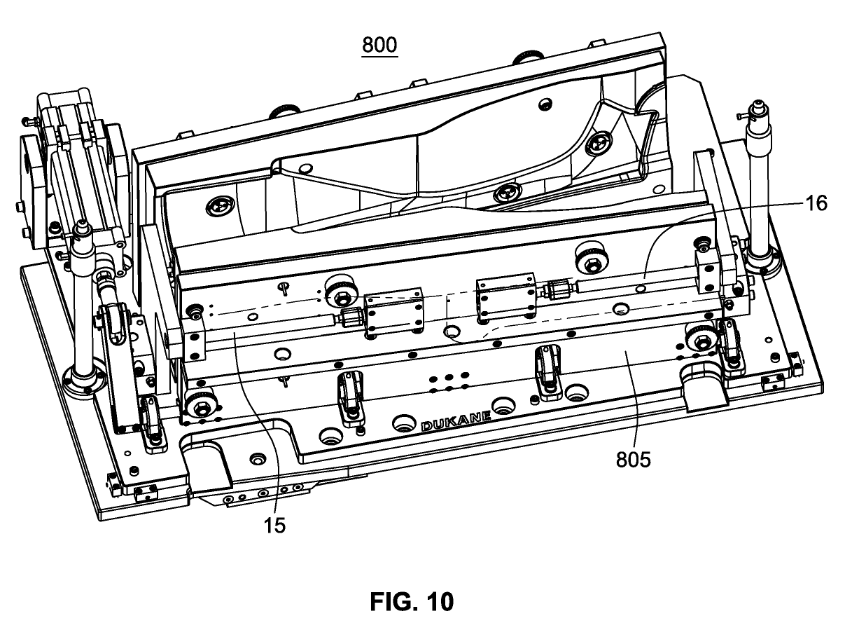

FIG. 9 shows a top plan view of the lower tool portion 800. FIG. 10 shows a perspective view like that of FIG. 9 with the door 805 closed and locking pins 15 and 16 engaged or ready to be engaged in end brackets 517 and 518 (FIG. 5).

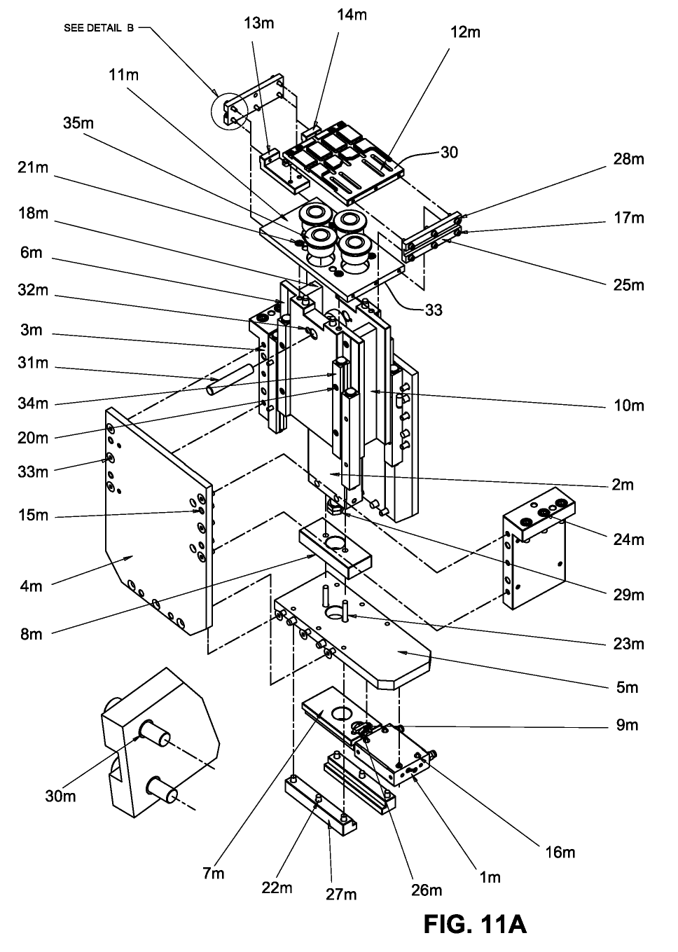

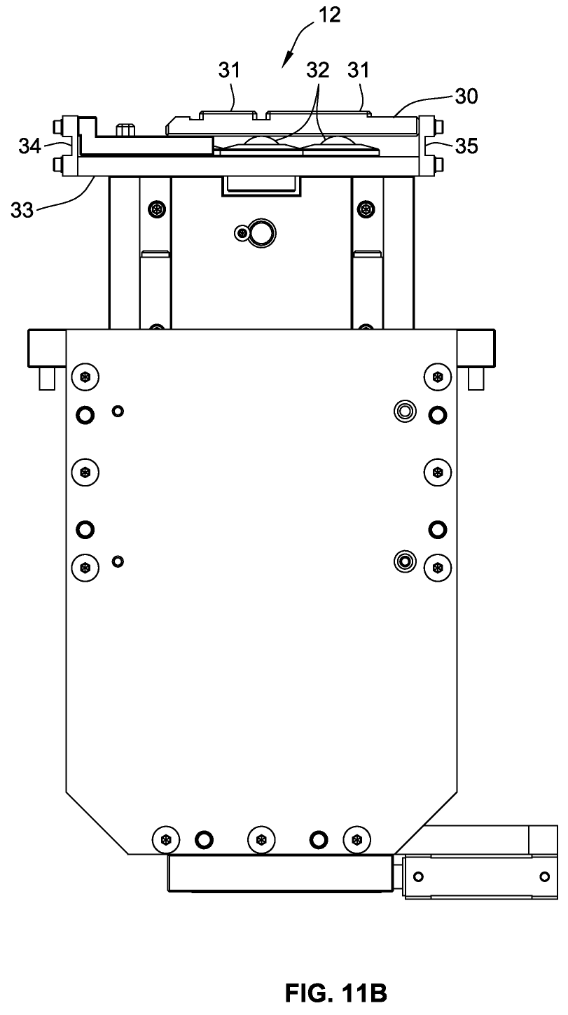

An exploded detailed view of the resonant mount 12 is shown in FIG. 11A. A parts list identifying the various parts of the resonant mount is provided in Appendix A. In one embodiment, the resonant mount 12 is pneumatically actuated between a lowered position and a raised position.

A side view of the resonant mount 12 in the raised position is shown in FIG. 11B. A top plate 30 has a number of knurled pads 31 attached to its upper surface, so that the part to be vibrated is securely gripped by the mount when a vertical clamping force is applied to press the part and the mount firmly together. The knurled surfaces 31 ensure that there is no relative movement between the mount 12 and the workpiece during vibratory movement.

The top plate 30 is supported on an array of roller bearings 32 carried by a stationary lower plate 33 that is rigidly mounted in a fixed position. A pair of urethane springs 34 and 35 interconnects the two plates 30 and 33 at their opposite ends. With this arrangement, the top plate 30 can move back and forth relative to the lower plate 33, in the x-axis direction, to accommodate the vibratory movement of the upper tooling portion 600 and the part secured to it, while maintaining the upper surface of the mount 12 at a fixed elevation. Vertical clamping forces are transmitted through the top plate 30 and the roller bearings 32 to a substrate that supports the mount 12.

The urethane springs 34 and 35 allow relative movement between the two plates 30 and 33, and also bias the top plate 30 toward a centered position. Thus, the upper tooling portion 600, the workpiece attached to that tooling, and the resonant mount 12 all go into resonance together, while maintaining the desired vertical clamping forces on all these elements. The roller bearings 32 bear the full clamp load of the top plate 30 and maintain the desired vertical position in the clamp direction. The urethane springs flex back and forth along the x axis, returning the top plate 30 to its center position when a weld cycle is completed. The lower plate 33 provides a stationary anchor and mount point for the assembly.

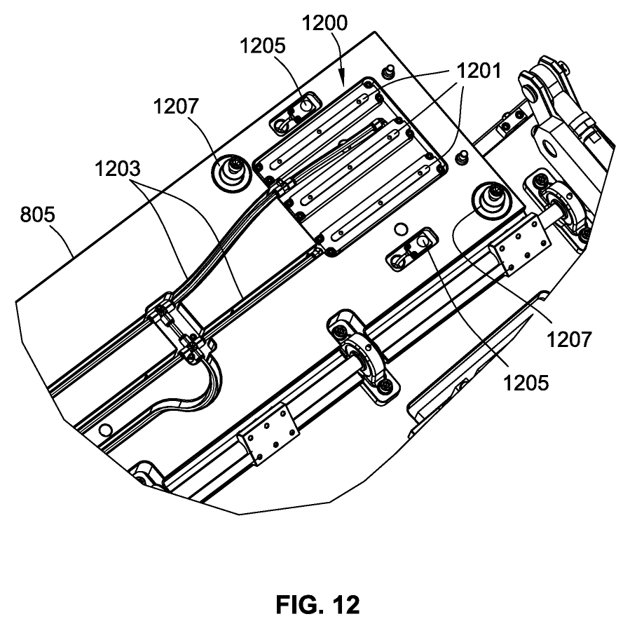

FIG. 12 is a partial cut-way view of a door assembly 805 showing a pneumatic clamp diaphragm 1200 used to apply pressure to a subassembly during vibration welding. In the illustrated embodiment, three pneumatic clamp assemblies 1201 are provided as part of the pneumatic clamp diaphragm 1200. The pneumatic clamp assemblies 1201 are supplied by pneumatic supply lines 1203. During the course of a vibration welding operation, air pressure supplied through the supply lines 1203 is increased from a starting value to an ending value, causing an associated nest holding a subassembly being vibration welded to move toward another subassembly being vibration welded. A corresponding pneumatic clamp diaphragm (not shown) is provided in conjunction with the fixed nest 13 (fixed in the sense of not being mounted to a door assembly). Analog proximity sensors 1205 are used to sense the position of the nests during progression of the vibration welding operation, enabling feedback to be displayed to an operator. More particularly, as the pneumatic clamp diaphragm 1200 expands, it pushes away a contoured nest (not shown), causing it to be displaced along guide pins 1207. In an exemplary embodiment, the contoured nests are metal, and the analog proximity sensors 1205 sense the displacement of the contoured nest away from a rest position of nearest proximity.

Each of the nest structures 13 and 14, therefore, may be considered as having a moving portion and a backing portion. During the welding operation, pressure applied to the nest structures 13 and 14 causes the moving portions of the nest structures 13 and 14 to advance toward each other along their respective guide pins until they reach the pre-adjusted hard stops set by the adjustments 21 and 22 (FIG. 8).

Note that the particular configuration of the pneumatic clamp diaphragm, as well as numerous other specific aspects of the tooling described, will vary from application to application in accordance with the particulars of the subassemblies to be vibration welded. Furthermore, a pneumatic clamp assembly is just one example of a linear actuator that may be used. Various other types of linear actuators may be used to achieve the same effect of maintaining desired pressure during the course of a vibration weld.

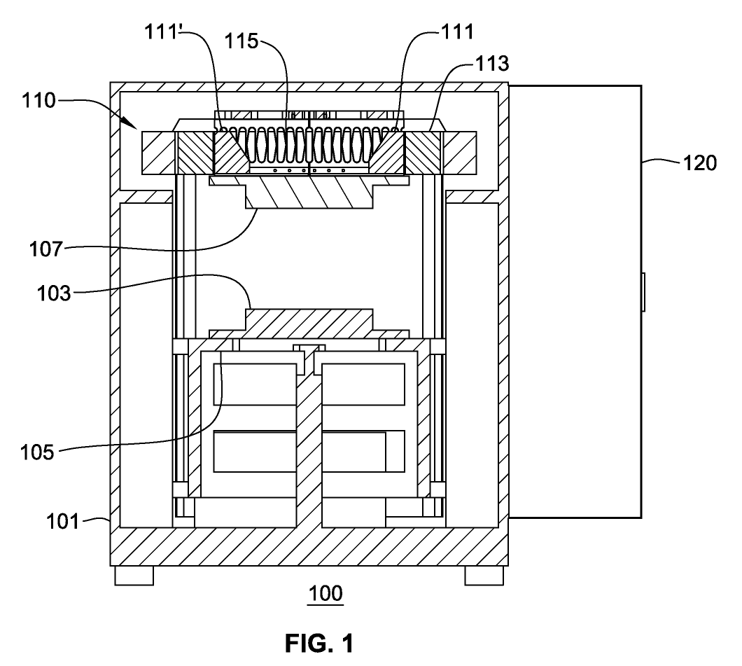

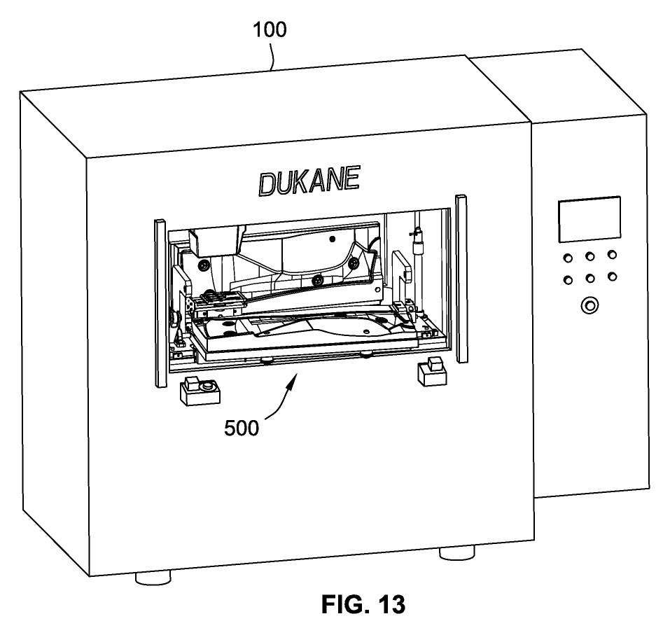

The vibration welding tool 500 may be used in conjunction with a known vibration welding machine 100, as illustrated in FIG. 13. In the illustrated embodiment, the upper tool portion is coupled by springs to the vibrating upper nest 107 (FIG. 1) of the vibration welding machine 100. Bolts holes 601 used for this purpose are shown in FIG. 6.

In operation, one of the parts to be welded to the part to be vibrated is placed into the stationary rear nest 13 (FIG. 8) that positions the nested part adjacent the rear vertical surface of the part to be vibrated. In the example of FIG. 2, the part placed into the rear nest 13 is the left panel C. The part placed in the rear nest 13 is held in place by vacuum applied to the group of ports 13a.

After the part has been placed in the rear nest 13, the part to be vibrated is placed on the resonant mount 12, and a vacuum switch initiates the raising of the resonant mount 12 to the position illustrated in FIG. 5. The elevation of the top surface of the resonant mount 12 fixes the elevation of the part to be vibrated, so that it is properly aligned with the two parts in the nests 13 and 14. In the example of FIG. 2, the part placed on the resonant mount 12 is the bin A.

The second part to be welded to the part to be vibrated is placed into the front nest 14 that is initially in a horizontal position, as shown in FIG. 5, and is then pivoted upwardly around its inner edge to position the nested part adjacent the front vertical surface of the part to be vibrated. Pivoting movement of the front nest 14 is effected by the pneumatic cylinder 514a connected to the nest 14 via linkage 514b. After the front nest 14 has reached its vertical position, the pair of locking pins 15 and 16 are advanced through mating apertures in the pair of end brackets 517 and 518 (FIG. 5) to lock the nest 14 securely in its vertical position. Provision may be made for the positions of the brackets 17 and 18 to be pre-adjusted to control the final vertical position of the front nest 14. In the example of FIG. 2, the part placed into the front nest 14 is the right panel B. The part placed in the front nest 14 is held in place by vacuum applied to the group of suction ports 14a.

FIG. 4B illustrates in simplified form the final positioning of both the tooling and the parts to be welded. As seen therein, the front and back vertical surfaces of the vibrating part A include multiple ribs 20 (“weld beads”) that engage the opposed vertical surfaces of the stationary parts B and C. During vibratory motion of the part A, the parts B and C are advanced against the ribs 20 by a force applied along an axis extending between the front and back of the machine. The heat generated by friction at each interface between the vibrating and stationary surfaces causes the material in the ribs 20 to melt and ultimately weld the parts together. Pressure is maintained on the adjoining parts until the molten material in the interfaces re-solidifies. During the melting of the material in the ribs 20, the pressure applied to the nests 13 and 14 causes them to advance toward each other until the pre-adjusted hard stops (adjustments 21 and 22, FIG. 8) are reached. Proximity sensors embedded in the nests 13 and 14 (e.g., proximity sensors 1205 of FIG. 12) are used to measure the actual distance of the melt in the two interfaces, and these distances may be displayed on the control panel of the welding machine.

After the welds have been completed, the locking pins 15 and 16 are retracted (disengaged). The front nest 14 is then pivoted downwardly to its original horizontal position, and the resonant mount 12 is lowered to its retracted position.

It is known to tune a vibration welding machine with a particular upper tool installed, to identify the resonant frequency of the system with that specific tool. The operating frequency, which is typically within a range from about 100 Hz to about 500 Hz, cannot be too far away from the resonant frequency of the mechanical assembly to be vibrated. This tuning of the machine is typically done with only the upper tool, i.e., without any workpieces and without any coupling of the upper tool to the lower tooling.

With the resonant mount described above, the tuning operation is carried out with the center workpiece (to be vibrated) in place on the upper tool 10 and clamped against the resonant mount 12. Thus, the resonant frequency is identified for a machine in which the entire mechanical assembly to be vibrated has been installed.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

APPENDIX A
FIG. 11A PARTS LIST
LOWER SLIDER ASSEMBLY BILL OF MATERIALS

| ITEM#: | PART#: | DESCRIPTION: |
|---|---|---|
| 1m | 161279_DZF-40-25-A-P-A_INST | FESTO 40 MM BORE 25 MM STROKE FLAT CYL |
| 2m | 161290_DZF-50-100-A-P-A-S2 | FESTO 50 MM BORE 100 MM STROKE FLAT CYL |
| 3m | 459914_INTERTECH_715L_121 | LOWER SLIDER MOUNT |
| 4m | 459914_INTERTECH_715L_122 | LOWER SLIDER SIDE PLATE |
| 5m | 459914_INTERTECH_715L_123 | LOWER SLIDER ASM BOTTOM PLATE |
| 6m | 459914_INTERTECH_715L_124 | LOWER SLIDER MOVABLE SIDE PLATE |
| 7m | 459914_INTERTECH_715L_125 | LOWER SLIDER LOCK SLIDE |
| 8m | 459914_INTERTECH_715L_126 | SLIDER ASM. CYLINDER MOUNT SPACER |
| 9m | 459914_INTERTECH_715L_127 | SLIDE LOCK FLOATING ROD MOUNT |
| 10m | 459914_INTERTECH_715L_128 | SLIDER CROSS MEMBER |
| 11m | 459914_INTERTECH_715L_129 | SLIDER ASM. BALL TRANSFER PLATE |
| 12m | 459914_INTERTECH_715L_130 | SLIDER ASM. TOP KNURL PLATE |
| 13m | 459914_INTERTECH_715L_131 | SLIDER ASM. BIN LOCATOR LH |
| 14m | 459914_INTERTECH_715L_131_MIR | SLIDER ASM. BIN LOCATOR RH |
| 15m | IPPHD1002 | 10 MM PULL DOWEL PIN × 24 MM LONG |
| 16m | ISHCS0508 | M4 × .7 × 30 MM SOCKET HEAD CAP SCREW |
| 17m | ISHCS0605 | M5 × .8 × 20 MM SOCKET HEAD CAP SCREW |
| 18m | ISHCS0703 | M6 × 1 × 16 MM SOCKET HEAD CAP SCREW |
| 19m | ISHCS0705 | M6 × 1 × 25 MM SOCKET HEAD CAP SCREW |
| 20m | ISHCS0708 | M6 × 1 × 40 MM SOCKET HEAD CAP SCREW |
| 21m | ISHCS0802 | M8 × 1.25 × 16 MM SOCKET HEAD CAP SCREW |
| 22m | ISHCS0804 | M8 × 1.25 × 25 MM SOCKET HEAD CAP SCREW |
| 23m | ISHCS0809 | M8 × 1.25 × 50 MM SOCKET HEAD CAP SCREW |
| 24m | ISHCS0904 | M10 × 1.5 × 30 MM SOCKET HEAD CAP SCREW |
| 25m | MISU_UTSM6H10-120-40-F50-G25- | 70 DUR. URETANE RUBBER 6 HOLE |
| | N6 | |
| 26m | MISUMI_ANN12-1_25 | M16 × 1.5 NUT |
| 27m | MISUMI_GRRM30-150-15 | 150 MM LONG GIB |
| 28m | MISUMI_PWF5 | 5 MM FLAT WASHER |
| 29m | MISUMI_SANN16-1_5 | M16 × 1.5 NUT |
| 30m | MISUMI_SMKB5-10 | STEEL SLEEVE 10 MM LONG FOR M5 BOLT |
| 31m | MISUMI_SSFJ16-90 | 16 MM SHAFT 90 MM LONG |
| 32m | MSBS041 | M6 × 1 × 8 MM BUTTON HEAD CAP SCREW |
| 33m | MSFS0503 | M8 × 1.25 × 25 MM FLAT HEAD CAP SCREW |
| 34m | NB_SV9200-9V | NB CROSS ROLLER GUIDE |
| 35m | REID_SKF_3013 | REID HEAVY DUTY BALL TRANSFER |

1. A linear vibration welding method of simultaneously welding a first thermoplastic part to second and third thermoplastic parts, said method comprising
fastening said first part to a tool mounted for linear vibration, said tool being connected to spring members urging said tool toward a central position and responsive to displacement of said tool from said central position for urging said tool back to said central position,
fastening said second and third parts in stationary positions with surfaces of said second and third parts to be welded to said first part positioned adjacent surfaces of said first part,
pressing said second and third parts against said first part while (1) clamping said first part between said tool and a resonant mount and (2) imparting vibratory movement to said tool and thus to said first part in a direction substantially parallel to the surfaces to be welded.

2. The method of claim 1 in which said resonant mount is supported on roller bearings.

3. The method of claim 2 in which said resonant mount includes a lower plate carrying said roller bearings and a plurality of springs coupling said top plate to said lower plate.

4. A method of simultaneously forming vibration welds between three or more subassemblies, comprising:
holding the three or more subassemblies in a desired relation to one another to define at least two different weld planes; and
vibrating at least one of the subassemblies to simultaneously form a vibration weld in each of the at least two different weld planes.

5. The method of claim 4, comprising vibrating a first one of the subassemblies using linear vibration.

6. The method of claim 5, comprising pressing a second one of the subassemblies against the first one of the subassemblies during linear vibration thereof, and pressing a third one of the subassemblies against the first one of the subassemblies during linear vibration thereof.

7. The method of claim 6, comprising applying pressure to one of the subassemblies through a resonant mount structure comprising a bearing-mounted spring-biased contacting surface.

8. A vibration welding tool for simultaneously forming vibration welds between three or more subassemblies, comprising:
tooling for holding the three or more subassemblies in a desired relation to one another to define at least two different weld planes; and
a mechanism allowing for vibratory movement of at least one of the subassemblies to simultaneously form a vibration weld in each of the at least two different weld planes.

9. The vibration welding tool of claim 8, wherein the mechanism allowing for vibratory movement is configured to allow linear vibration of a first one of the subassemblies.

10. The vibration welding tool of claim 9, wherein the tooling comprises a pressure mechanism for pressing a second one of the subassemblies against the first one of the subassemblies during linear vibration thereof, and for pressing a third one of the subassemblies against the first one of the subassemblies during linear vibration thereof.

11. The vibration welding tool of claim 10, wherein the pressure mechanism comprises a first linear actuator or array of linear actuators for pressing a second one of the subassemblies against the first one of the subassemblies during linear vibration thereof, and a second linear actuator or array of linear actuators for pressing a third one of the subassemblies against the first one of the subassemblies during linear vibration thereof.

12. The vibration welding tool of claim 11, wherein said tooling comprises:
a first nest structure comprising a movable portion and a backing portion for holding the second one of the subassemblies; and
a second nest structure comprising a movable portion and a backing portion for holding the third one of the subassemblies;
wherein the first linear actuator or array of linear actuators is arranged to cause first displacement of the movable portion of the first nest structure away from the backing portion of the first nest structure; and the second linear actuator or array of linear actuators is arranged to cause second displacement of the movable portion of the first nest structure away from the backing portion of the first nest structure.

13. The vibration welding tool of claim 12, comprising sensors for sensing said first displacement and said second displacement.

14. The vibration welding tool of claim 13, comprising a hinged door assembly, the door assembly comprising the second nest structure, the second linear actuator or array of linear actuators, and at least one of said sensors.

15. The vibration welding tool of claim 10, wherein the mechanism allowing for vibratory movement comprises a resonant mount structure comprising a bearing-mounted spring-biased contacting surface for applying pressure to one of the subassemblies.

16. A vibration welding system for simultaneously forming vibration welds between three or more subassemblies, comprising:
tooling for holding the three or more subassemblies in a desired relation to one another to define at least two different weld planes; and
a mechanism allowing for vibratory movement of at least one of the subassemblies to simultaneously form a vibration weld in each of the at least two different weld planes; and
a source of vibratory energy coupled to the mechanism allowing for vibratory movement.

17. The vibration welding system of claim 16, wherein the mechanism for allowing vibratory movement is configured to allow linear vibration of a first one of the subassemblies.

18. The vibration welding system of claim 17, wherein the tooling comprises a pressure mechanism for pressing a second one of the subassemblies against the first one of the subassemblies during linear vibration thereof, and for pressing a third one of the subassemblies against the first one of the subassemblies during linear vibration thereof.

19. The vibration welding tool of claim 18, wherein the mechanism allowing for vibratory movement comprises a resonant mount structure comprising a bearing-mounted spring-biased contacting surface for applying pressure to one of the subassemblies.

20. A resonant mount for use in a vibration welding machine, the resonant mount comprising a bearing-mounted spring-biased contacting surface for applying pressure to one of the subassemblies.

21. The resonant mount of claim 20, comprising a lift mechanism for moving the contacting surface between a lowered position and a raised position in preparation for vibration welding.

22. A method of tuning a vibration welding machine, comprising:
securing a subassembly to a tooling portion that is vibrated;
applying a clamping force to the subassembly through a resonant mount comprising a bearing-mounted spring-biased contacting surface for applying pressure to the subassembly; and
vibrating the combination of the subassembly, the tooling portion that is vibrated and the resonant mount to identify a resonant frequency.
